(19) United States
(12) Patent Application Publication
(10) Pub. No.: US 2013/0050152 A1
(43) Pub. Date: Feb. 28, 2013

(54) COORDINATE POSITIONING METHOD FOR DISPLAY

(71) Applicants: Yu-Wen HUANG, New Taipei City (TW); Yih-Sheng CHAO, New Taipei City (TW); Hsu-Chih CHEN, New Taipei City (TW)

(72) Inventors: Yu-Wen HUANG, New Taipei City (TW); Yih-Sheng CHAO, New Taipei City (TW); Hsu-Chih CHEN, New Taipei City (TW)

(73) Assignee: AVER INFORMATION INC., New Taipei City (TW)

(21) Appl. No.: 13/215,251

(22) Filed: Aug. 23, 2011

(51) Int. Cl. G06F 3/033

(52) U.S. Cl. 345/179

(57) ABSTRACT

A coordinate positioning method to control the movement of the vernier on the display is disclosed. The method includes operating the electronic pen on the substrate having the waterprint pattern, capturing the image of the least one basis pixel where the electronic pen located on, transforming the basis pixel to the current coordinate, which is an absolute coordinate, and moving the vernier on the display to a position corresponding to the current coordinate.

### BACKGROUND

1. Field of Invention

The present invention relates to a positioning method for positioning vernier on display. More particularly, the present invention relates to a positioning method for positioning vernier on display by using absolute coordinate.

2. Description of Related Art

Along with the development of 3C (Computer, Communications and Consumer) industries, more and more people are using electronic devices as an assistance tool in their daily life. Common electronic devices include personal digital assistants (PDAs), personal computers, tablet computers, mobile phones, smart phones and so on. The number of people using electronic devices is increasing, as is the number of functions required on electronic devices.

No matter what kind of electronic devices, there is a need to receiving commands from user while operating functions. The operation convenience and integration of input interfaces of the electronic devices become important. For example, resistance touch panels, capacitor touch panels, mouses, or keyboards are touched, rolled, pressed or moved to operate the electronic devices. However, resistance touch panels or capacitor touch panels may increase the cost of the electronic devices.

### SUMMARY

The invention provides a coordinate positioning method for a display to control a vernier displayed on the display.

An embodiment of the invention provides a coordinate positioning method for a display utilized in an electronic device for controlling a vernier displayed on the display. A watermark pattern is provided on a substrate, in which the watermark pattern includes a plurality of different basis pixels, and each of the basis pixels is related to one absolute coordinate. An electronic pen with an image sensor on the substrate, in which the electronic pen is located on at least one of the basis pixels and captures an image of the least one basis pixel. The captured image of the least one basis pixel is transformed to a current coordinate. The vernier on the display is moved to a position corresponding to the current coordinate.

The method further includes utilizing discrete cosine transform technique or 2D linear transform technique to transform the captured image of the least one basis pixel to the current coordinate. The method optionally includes utilizing interpolation method, least square method, or kalman filter to calculate the current coordinate. The substrate can be a paper, and the waterprint pattern is printed on the paper. The substrate can be the display, and the waterprint pattern is a transparent pattern or a semi-transparent pattern. The method further includes enabling a waterprint function to overlap the waterprint pattern on a screen image of the display. The method further includes using algorithm to exclude a part of the captured screen image. The method further includes a screen resolution of the display to providing the waterpaint pattern. The captured image of the least one basis pixel can be transferred to the electronic device, in which the current coordinate is transformed in the electronic device. The current coordinate can be transferred to the electronic device after the electronic device transforming the captured image of the least one basis pixel to the current coordinate. The current coordinate is absolute coordinate.

Another embodiment of the invention provides an electronic pen. The electronic pen includes a casing, an image sensor disposed in the casing for capturing the least one basis pixel, a lens module disposed in the casing in front of image sensor, and a transferring module disposed in the casing and connected to the electronic device. The electronic pen further includes a processor disposed in the casing and connected to the image sensor for transforming the capture image of the least one basis pixel to the current coordinate and providing the current coordinate to the transferring module. The captured image of the least one basis pixel is transferred to the electronic device to be transformed into the current coordinate. The electronic pen further includes a light source disposed near the image sensor.

The coordinate positioning method for display disclosed in above embodiments of the invention provides a method to control the movement of the vernier on the display. The method includes operating the electronic pen on the substrate having the waterprint pattern, capturing the image of the least one basis pixel where the electronic pen located on, transforming the basis pixel to the current coordinate, which is an absolute coordinate, and moving the vernier on the display to a position corresponding to the current coordinate.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a schematic diagram of an embodiment of the waterprint pattern utilized in the coordinate positioning method for display of the invention;

FIG. 2 is a flow chart of a first embodiment of the coordinate positioning method for display of the invention;

FIG. 3 is a flow chart of a second embodiment of the coordinate positioning method for display of the invention;

FIG. 4 is a flow chart of a third embodiment of the coordinate positioning method for display of the invention;

FIG. 5 is a flow chart of a fourth embodiment of the coordinate positioning method for display of the invention;

FIG. 6 is a schematic diagram of an embodiment of the electronic pen utilized in the coordinate positioning method for display of the invention; and

FIG. 7 is schematic diagram of another embodiment of the coordinate positioning method for display using the electronic pen shown in FIG. 6.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

Due to the increased cost of the electronic device by the resistance touch panels or the capacitor touch panels, the present invention provides a coordinate positioning method for a display by using image-decoding technique. The method can be utilized in the electronic device with a display. The electronic pen having image capturing function can capture the image of a waterprint pattern. The captured image of the waterprint pattern is transformed into the corresponding absolute coordinate in order to control a vernier displayed on the display.

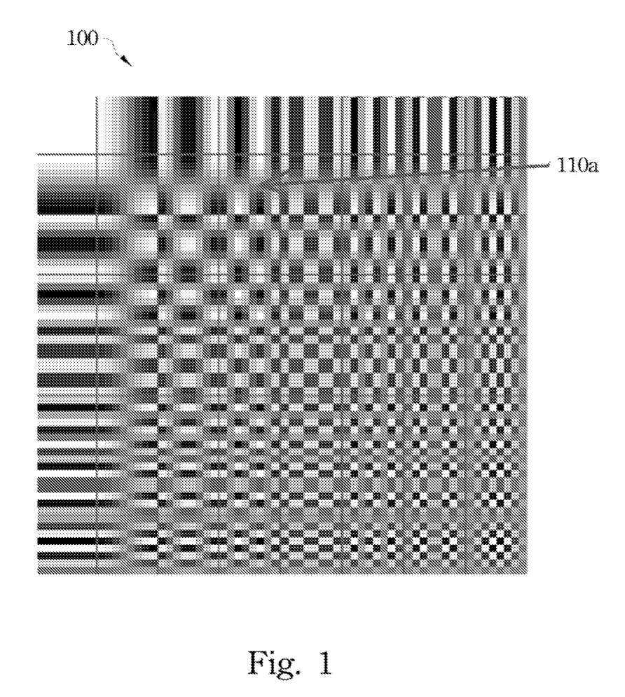

FIG. 1 is a schematic diagram of an embodiment of the waterprint pattern utilized in the coordinate positioning method for display of the invention. The waterprint pattern 100 includes a plurality of different basis pixels 110. An 8*8 matrix of the basis pixels 110 is disclosed in the embodiment. More particularly, the waterprint pattern 100 is divided into 8 segments along longitudinal direction and the cross direction and includes 64 basis pixels 110. Each of the basis pixels 110 is unique and is different from each other in the waterprint pattern 100. The waterprint pattern 100 can be also formed by choosing basis pixels 110 of different pattern or gray value and further combining the basis pixels 110 according to the requirement.

Each of the basis pixels 110 is unique and is different from each other, therefore the pattern of each basis pixel 110 can be used to position. Namely, each of the basis pixels 110 is related to one absolute coordinate respectively. For example, the basis pixel 110a represents the absolute coordinate of (3,1). The present invention utilizes this concept and uses the waterprint pattern 100 to position coordinate. The present invention can be utilized in tablet computers, personal computers, notebook computers, smart phone, projectors, or other electronic devices with displays.

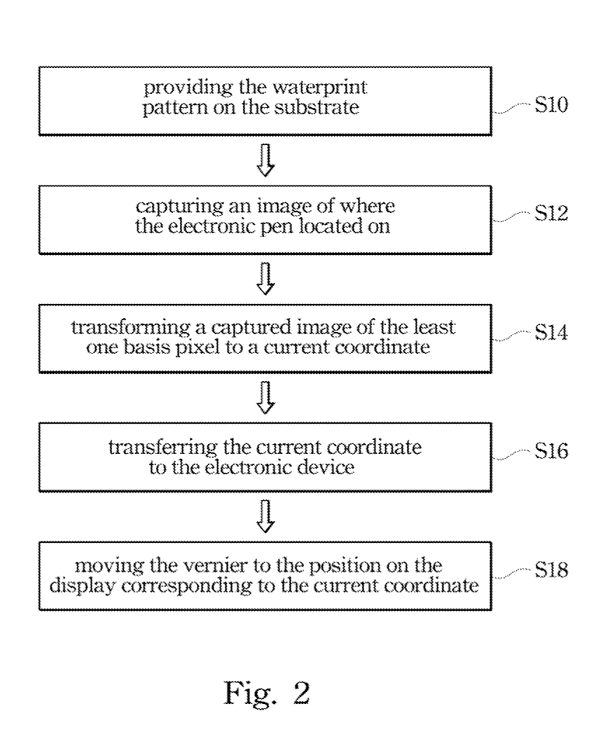

FIG. 2 is a flow chart of a first embodiment of the coordinate positioning method for display of the invention. The coordinate positioning method is utilized in the electronic devices to control the movement of the vernier on the display. Step S10 is providing the waterprint pattern on the substrate. The waterprint pattern is consisted of plural basis pixels, and each of the basis pixels is unique and is different from each other. Each basis pixel represents one absolute coordinate respectively. The relation between the basis pixels, waterprint pattern, and the absolute coordinate is described in FIG. 1. The substrate of the present embodiment can be a paper, and the waterprint pattern is printed on the paper.

An electronic pen having an image sensor is operated on the substrate in step S12. The electronic pen is located on at least one basis pixel. The image sensor of the electronic pen captures the image of the at least one basis pixel where the electronic pen is located on.

The captured image of the least one basis pixel is transformed to a current coordinate in step S14. Step S14 includes using discrete cosine transform (DCT) technique or 2D linear transform technique to transform the captured image of the least one basis pixel to the current coordinate, in which the current coordinate is the absolute coordinate of the position of the electronic pen located. For example, the captured image is the basis pixel 110a shown in FIG. 1, and the matrix of the image transformed by discrete cosine transform technique is shown as following:

$$[ \begin{matrix}0 & 0 & 0 & 0 & 0 & 0 & 0 & 0 \\ 0 & 0 & 0 & 1 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0 \\ 0 & 0 & 0 & 0 & 0 & 0 & 0 & 0\end{matrix} ]$$

Thus we can know that the current coordinate of the electronic pen is (3,1).

However, if the electronic pen is located between more than one basis pixels, step S14 further includes utilizing interpolation method, least square method, or kalman filter to calculate the current coordinate after the captured image of basis pixels is transformed to absolute coordinate.

Step S14 can be executed in the electronic pen. Then the current coordinate is transferred to the electronic device is step S16. The current coordinate can be transferred by cable or wireless way in step S16.

In step S18, the electronic device receives the current coordinate provided from the electronic pen. Then an algorithm is used to calculate the position on the display corresponding to the current coordinate, and the vernier is moved to the position on the display corresponding to the current coordinate.

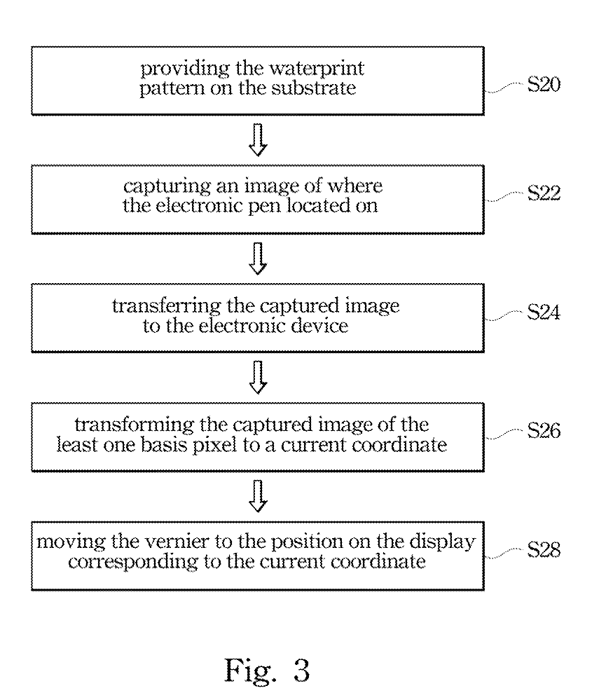

FIG. 3 is a flow chart of a second embodiment of the coordinate positioning method for display of the invention. Step S20 is providing the waterprint pattern on the substrate. The substrate of the present embodiment can be a paper, and the waterprint pattern is printed on the paper.

The electronic pen having an image sensor is operated on the substrate in step S22. The electronic pen is located on at least one basis pixel. The image sensor of the electronic pen captures the image of the at least one basis pixel where the electronic pen is located on.

The captured image of the least one basis pixel is transferred to the electronic device with cable pr wireless way in step S24.

The captured image of the least one basis pixel is transformed to a current coordinate in step S26. Step S26 includes using discrete cosine transform (DCT) technique or 2D linear transform technique to transform the captured image of the least one basis pixel to the current coordinate, in which the current coordinate is the absolute coordinate of the position of the electronic pen located.

An algorithm is used to calculate the position on the display corresponding to the current coordinate, and the vernier is moved to the position on the display corresponding to the current coordinate in step S28.

The waterprint pattern can be printed on the paper, and the electronic pen can be operated thereon. In some embodiments, the waterprint pattern can be provided on the display to provide function as touch panel, details thereof are described as follows.

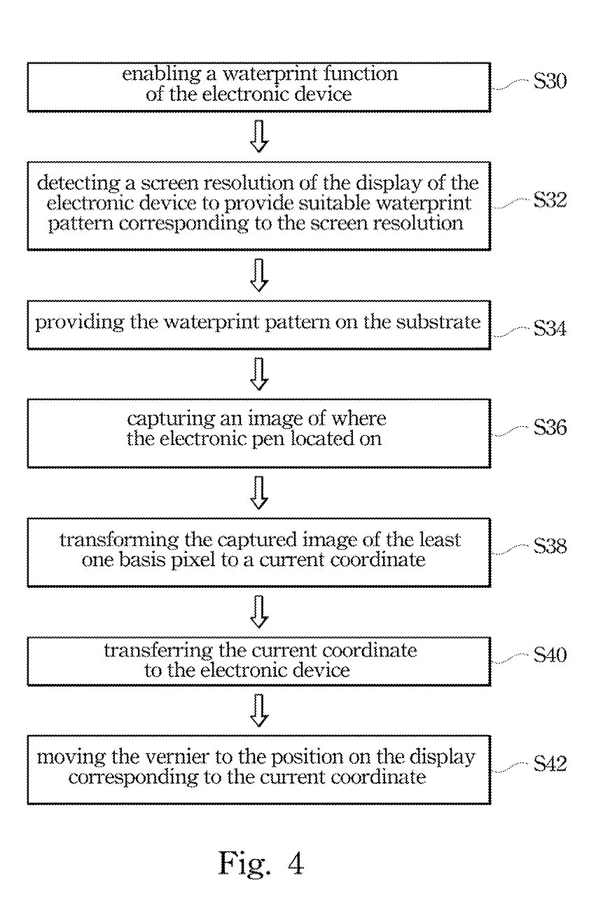

FIG. 4 is a flow chart of a third embodiment of the coordinate positioning method for display of the invention. Step S30 is enabling a waterprint function of the electronic device. Step S32 is detecting a screen resolution of the display of the electronic device in order to provide suitable waterprint pattern corresponding to the screen resolution. The waterprint pattern is consisted of plural basis pixels, and each of the basis pixels is unique and is different from each other. Each basis pixel represents one absolute coordinate respectively. The number of the basis pixels is greater when the screen resolution is higher.

The waterprint pattern is provided on the substrate in step S34. The substrate in this embodiment is the display of the electronic device, and the waterprint pattern is overlapped on the display of the electronic device. In case of waterprint pattern covering the original display image of the display, the waterprint pattern is preferably a semi-transparent pattern or a transparent pattern, which can be captured by the image sensor of the electronic pen but cannot be seen by naked eyes.

The electronic pen having an image sensor is operated on the display in step S36. The electronic pen is located on at least one basis pixel. The image sensor of the electronic pen captures the image of the at least one basis pixel where the electronic pen is located on.

The captured image of the least one basis pixel is transformed to a current coordinate in step S38. The image captured by the electronic pen may include a part of the waterprint pattern and a part of the screen image of the display; therefore, step S38 further includes using algorithm to exclude the part of the captured screen image. Then discrete cosine transform (DCT) technique or 2D linear transform technique is used to transform the captured image of the least one basis pixel to the current coordinate, in which the current coordinate is the absolute coordinate of the position of the electronic pen located. Step S38 may optionally include using interpolation method, least square method, or kalman filter to calculate the current coordinate after the captured image of basis pixels is transformed to absolute coordinate when the electronic pen is located between more than one basis pixels. The image captured by the electronic pen includes the waterprint pattern and the original screen image, thus an algorithm is required to exclude the original screen image.

Step S40 is transferring the current coordinate to the electronic device. The current coordinate can be transferred by cable or wireless way.

In step S42, the electronic device receives the current coordinate and uses and algorithm to calculate the position on the display corresponding to the current coordinate, and the vernier is moved to the position on the display corresponding to the current coordinate.

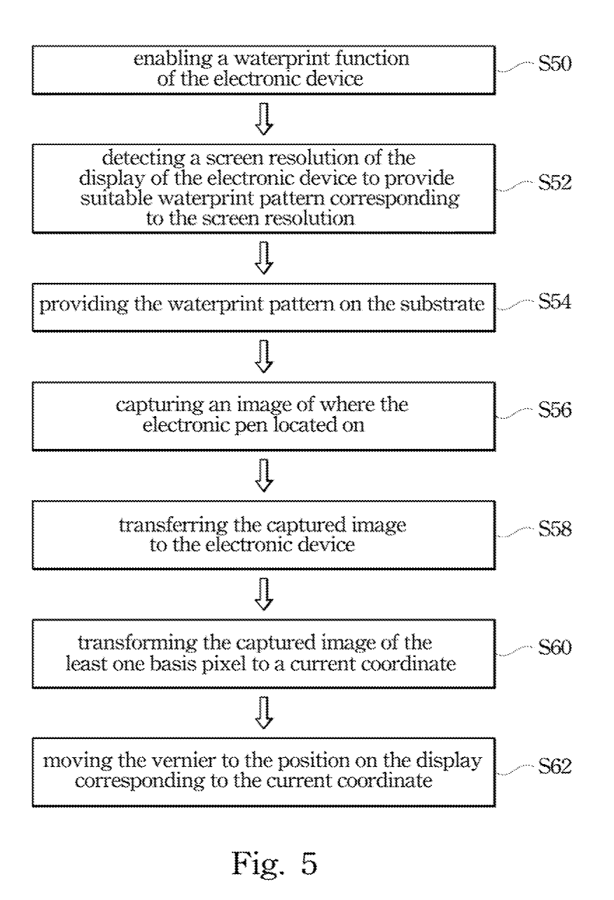

FIG. 5 is a flow chart of a fourth embodiment of the coordinate positioning method for display of the invention. Step S50 is enabling a waterprint function of the electronic device. Step S52 is detecting a screen resolution of the display of the electronic device in order to provide suitable waterprint pattern corresponding to the screen resolution. The waterprint pattern is provided on the substrate in step S54. The substrate in this embodiment is the display of the electronic device, and the waterprint pattern is overlapped on the display of the electronic device. The waterprint pattern is preferably a semi-transparent pattern or a transparent pattern. The electronic pen having an image sensor is operated on the display in step S56. The electronic pen is located on at least one basis pixel. The image sensor of the electronic pen captures the image of the at least one basis pixel where the electronic pen is located on. The captured image of the least one basis pixel is transferred to the electronic device in step S58. Step S60 is transforming the least one basis pixel to current coordinate. Step S60 includes using algorithm to exclude the original screen image. Then step S60 is using algorithm to calculate the position on the display corresponding to the current coordinate, and the vernier is moved to the position on the display corresponding to the current coordinate.

As disclosed above, the present invention utilizes discrete cosine transform (DCT) technique or 2D linear transform technique to transform the captured image of the least one basis pixel of the waterprint pattern to the absolute coordinate in order to position the vernier. The waterprint pattern can be formed on the paper or the display of the electronic device. The step of transforming the captured image of the least one basis pixel to the absolute coordinate by discrete cosine transform (DCT) technique or 2D linear transform technique can be executed in the electronic pen or the electronic device. Present invention optionally includes using interpolation method, least square method, or kalman filter to calculate the current coordinate after the captured image of basis pixels is transformed to absolute coordinate when the electronic pen is located between more than one basis pixels. The number of the basis pixels in the waterprint pattern is decided by the screen resolution of the display.

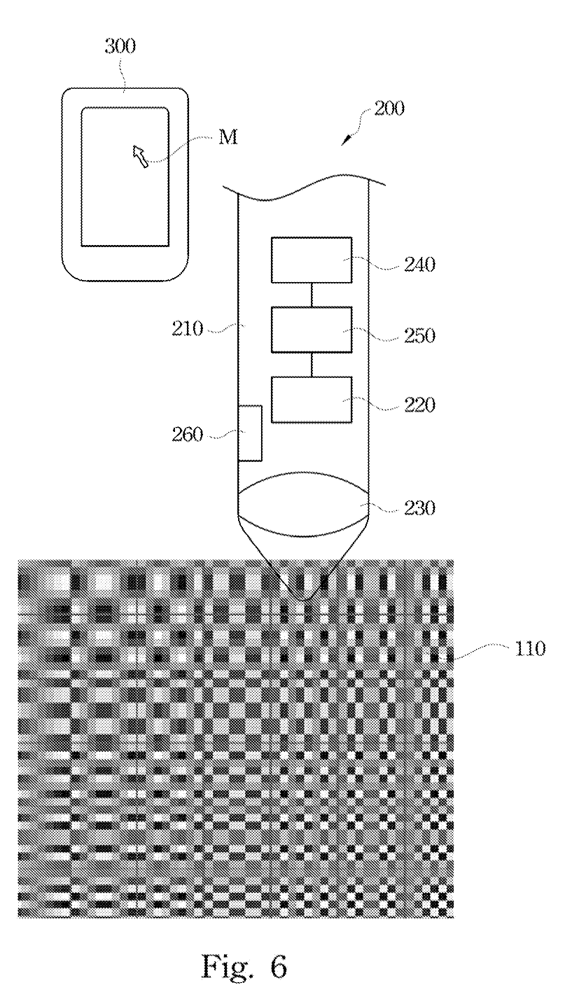

FIG. 6 is a schematic diagram of an embodiment of the electronic pen utilized in the coordinate positioning method for display of the invention. The electronic pen 200 includes a casing 210, the image sensor 220, a lens module 230, a transferring module 240, a processor 250, and a light source 260. The casing 210 can be a pen-shaped casing, which is easily held and operated. The image sensor 220 is disposed in the casing 210 to capture the image of the least one basis pixel. The image sensor 220 can be a complementary metal oxide semiconductor (CMOS) or a charge coupled device (CCD).

The lens module 230 is disposed in the casing 210 and is in front of the image sensor 220. The lens module 220 can be a combination of concave lens and convex lens.

The transferring module 240 is disposed in the casing 210. The transferring module 240 can be cable module or a wireless module, such as a blueteeth module or RFID module. The transferring module 240 connects the electronic pen 200 and the corresponding electronic device 300. The transferring module 240 transfers the current coordinate to the electronic device or transfers the captured image of the least one basis pixel to the electronic device 300.

The processor 250 is disposed in the casing 210. The processor 250 is connected to the image sensor 220 to process the image captured by the image sensor 220 and transform the basis pixel to the absolute coordinate. The process of transforming the basis pixel to the absolute coordinate can be executed in the electronic device 300.

The light source 260 is disposed in the casing 210 and near the image sensor 220 to provide light when the image sensor 220 captures image.

The electronic device 300 receives the current coordinate from the electronic pen 200 or transforms the basis pixel to the current coordinate, and then the vernier M on the display 310 of the electronic device 300 is moved to the position corresponding to the current coordinate. The basis pixel 110 is printed on the paper in this embodiment.

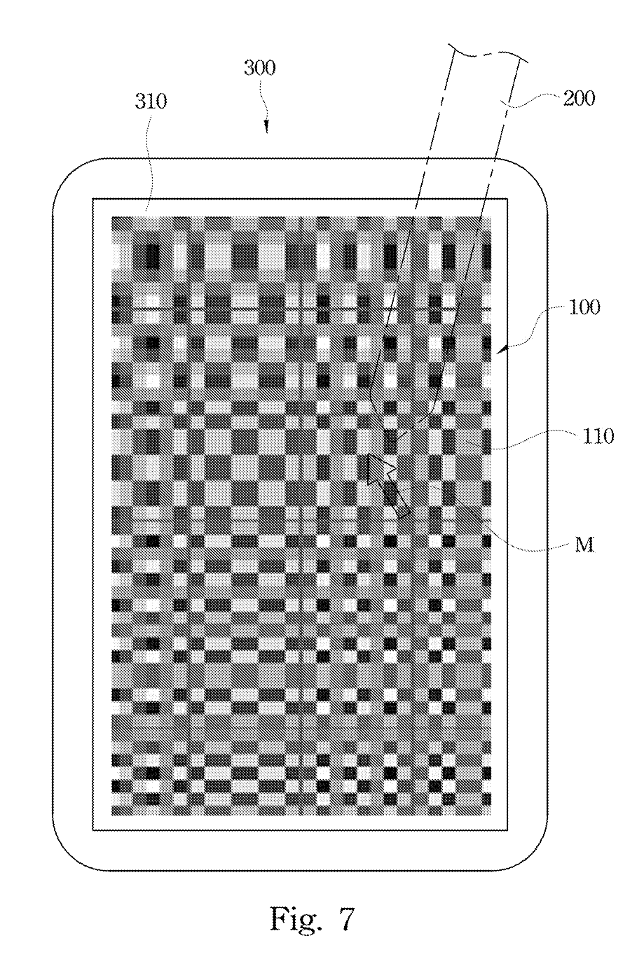

FIG. 7 is schematic diagram of another embodiment of the coordinate positioning method for display using the electronic pen 200 shown in FIG. 6. In this embodiment, the transparent or semi-transparent waterprint pattern is formed on the display 310 of the electronic device 300, and the electronic pen 200 is operated on the display 310 of the electronic device 300. The image of the basis pixel 110 captured by the electronic pen 200 is transformed to the current coordinate, and the vernier M on the display 310 of the electronic device 300 is moved to the position corresponding to the current coordinate.

The coordinate positioning method for display disclosed in above embodiments of the invention provides a method to control the movement of the vernier on the display. The method includes operating the electronic pen on the substrate having the waterprint pattern, capturing the image of the least one basis pixel where the electronic pen located on, transforming the basis pixel to the current coordinate, which is an absolute coordinate, and moving the vernier on the display to a position corresponding to the current coordinate.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A coordinate positioning method for a display utilized in an electronic device for controlling a vernier displayed on the display, the method comprising:
providing a watermark pattern on a substrate, wherein the watermark pattern includes a plurality of different basis pixels, and each of the basis pixels is related to one absolute coordinate;
operating an electronic pen with an image sensor on the substrate, wherein the electronic pen is located on at least one of the basis pixels and captures an image of the least one basis pixel;
transforming the captured image of the least one basis pixel to a current coordinate; and
moving the vernier on the display to a position corresponding to the current coordinate.

2. The coordinate positioning method for display of claim 1, further comprising utilizing discrete cosine transform technique or 2D linear transform technique to transform the captured image of the least one basis pixel to the current coordinate.

3. The coordinate positioning method for display of claim 2, further comprising utilizing interpolation method, least square method, or kalman filter to calculate the current coordinate.

4. The coordinate positioning method for display of claim 1, wherein the substrate is a paper, and the waterprint pattern is printed on the paper.

5. The coordinate positioning method for display of claim 1, wherein the substrate is the display, and the waterprint pattern is a transparent pattern or a semi-transparent pattern.

6. The coordinate positioning method for display of claim 5, further comprising enabling a waterprint function to overlap the waterprint pattern on a screen image of the display.

7. The coordinate positioning method for display of claim 6, further comprising using algorithm to exclude a part of the captured screen image.

8. The coordinate positioning method for display of claim 6, further comprising detecting a screen resolution of the display to providing the waterpaint pattern.

9. The coordinate positioning method for display of claim 1, further comprising transferring the captured image of the least one basis pixel to the electronic device, wherein the current coordinate is transformed in the electronic device.

10. The coordinate positioning method for display of claim 1, further comprising transferring the current coordinate to the electronic device after the electronic device transforming the captured image of the least one basis pixel to the current coordinate.

11. The coordinate positioning method for display of claim 1, wherein the current coordinate is absolute coordinate.

12. An electronic pen as claim 1, the electronic pen comprising:
a casing;
the image sensor disposed in the casing for capturing the least one basis pixel;
a lens module disposed in the casing in front of image sensor; and
a transferring module disposed in the casing and connected to the electronic device.

13. The electronic pen of claim 12, further comprising a processor disposed in the casing and connected to the image sensor for transforming the capture image of the least one basis pixel to the current coordinate and providing the current coordinate to the transferring module.

14. The electronic pen of claim 12, wherein the captured image of the least one basis pixel is transferred to the electronic device to be transformed into the current coordinate.

15. The electronic pen of claim 12, further comprising a light source disposed near the image sensor.
